(19) United States
(12) Patent Application Publication
(10) Pub. No.: US 2013/0264185 A1
(43) Pub. Date: Oct. 10, 2013

(54) Method and Means of Production Water Desalination

(71) Applicants: Alfredo B. Brillantes, JR., Stafford, TX (US); Frederick J. Polnisch, JR., Baytown, TX (US)

(72) Inventors: Alfredo B. Brillantes, JR., Stafford, TX (US); Frederick J. Polnisch, JR., Baytown, TX (US)

(21) Appl. No.: 13/609,628

(22) Filed: Sep. 11, 2012

Related U.S. Application Data
(60) Provisional application No. 61/620,057, filed on Apr. 4, 2012.

(51) Int. Cl. C02F 1/04; B01D 3/02; C02F 103/08

(52) U.S. Cl. 202/174

(57) ABSTRACT

The present invention comprises numerous methods and means for safe, effective and economical desalination of oily brine and brackish production water. Associated methods of operations and proposed systems and subsystems are also disclosed. The system also admits to waste heat recovery from internal combustion engine exhaust and jacket cooling water, utilizing the heat energy of a fuel feed to maximize system efficiency. The system and method are useful for desalinating not only oily brine water, but also brackish water, sea water, and waste treatment plant water, and could also be applied to other sources of waste heat and other low grade heats such as gas turbine exhaust systems, biomass, and energy from waste, etc.

### STATEMENT OF RELATED CASES

The present application claims the benefit of prior U.S. provisional application No. 61/620,057 filed Apr. 4, 2012.

### FIELD OF THE INVENTION

The invention relates generally to the cleaning and desalination of water, and in a particular though non-limiting embodiment to systems, methods and means for cleaning and desalinating production water obtained from an oil or gas well.

### BACKGROUND OF THE INVENTION

Oil pumped from a well is not produced in a pure form; rather, it is typically mixed with a brine solution. Accordingly, this solution is usually called production water. Subsequent treatment in a separation and storage tank unit separates the oil from the brine, primarily due to a difference in their respective densities. Consequently, oil is usually separated toward the top of the unit because it is lighter, whereas the brine tends to accumulates toward the bottom of the unit because it is heavier.

The oily brine disposal process is frequently a complicated and expensive operation. For example, the oily brine can only be disposed of at regulatory approved sites, which are sometimes located far from the well site. The cost of oily brine is therefore relative to the distance of the well site from the disposal site. An alternative approach, therefore, is to desalinate the brine water as much as possible, so that less waste product needs to be transported to storage sites.

Current desalination methods primary include reverse osmosis, and evaporation. Evaporation can be achieved in many different ways, for example, using multi steam flash units; multiple effect evaporators; vapor compression evaporators; and a combination of multiple effect evaporators and vapor compression evaporators of various arrangements. These approaches can, depending on system design and operation requirements, comprise a variety of either single stage evaporation effects and/or or multiple evaporation effects.

In multiple-effect evaporation, a single steam energy source is used to produce steam in a plurality of evaporators, applying a cascade of pressures and temperatures from one effect to the next. Feed flow is run in either a series concurrent flow or counter flow toward the steam flow. In either case, the concentration of the brine increases toward the direction of the flow.

Ordinarily skilled artisans will appreciate that the higher the salt concentration in the production water being desalinated, the higher the resulting viscosity of the fluid; thus, higher heat transfers resistance as well as a pressure drop through the heat exchanger. A selection of the specific type of desalination system will be dictated by the cost of operations, and especially the cost of fuel; in most cases, however, the use of evaporation technology is effectively negated by the prohibitive costs of fuel or energy.

There is, therefore, a longstanding but unmet need for a simple and efficient productions water desalination unit and methods of operating the same that overcome the inefficiencies and limitations of the existing prior art.

### OBJECT OF THE INVENTION

The present invention greatly reduces the cost of production water disposal by evaporating water from the brine, thereby significantly decreasing the volume. The product distillate can then be disposed of safely, and subsequently used for irrigation and other applications. The distillate can even be processed and converted into potable drinking water.

### SUMMARY OF THE INVENTION

The instant application discloses a plurality of systems and means for the safe, effective and economical desalination of oily brine and brackish production water. Associated methods of operations and proposed systems and subsystems are also disclosed. The system also admits to waste heat recovery from internal combustion engine exhaust and jacket cooling water, thereby utilizing the heat energy of a fuel feed to maximize system efficiency. The system and method are useful for desalinating not only oily brine water, but also brackish water, sea water, waste treatment plant water, flood water, etc.

In one specific though non-limiting embodiment, the claimed invention includes means for brine preparation; means for pre-heating brine using process heat recovery; means for producing heat energy from electricity generated and heat recovery from exhaust of the engine for evaporation; means for producing a first steam in a first effect heat exchanger; means for producing a second steam and a first distillate in a second effect heat exchanger; means for producing a third steam and a second distillate in a third effect heat exchanger; means for producing a third distillate in a condenser; and means for recovering process heat in a product heat recovery heat exchanger.

In a specific though limiting example embodiment of a method appropriate for operating the claimed system, the method includes disposing a means for brine preparation in communication with a means for pre-heating brine using process heat recovery; disposing the means for pre-heating brine using process heat recovery in communication with a means for evaporation; disposing the means for evaporation and transfer of heat energy using high temperature heat transfer fluid in communication with a means for producing a first steam in a first effect heat exchanger; disposing the means for producing a first steam in a first effect heat exchanger in communication with a means for producing a second steam and a first distillate in a second effect heat exchanger; disposing the means for producing a second steam and a first distillate in a second effect heat exchanger in communication with a means for producing a third steam and a second distillate in a third effect heat exchanger; disposing the means for producing a third steam and a second distillate in a third effect heat exchanger in communication with a means for producing a third distillate in a condenser; and disposing the means for producing a third distillate in a condenser in communication with a means for recovering process heat in a product heat recovery heat exchanger.

### BRIEF DESCRIPTION OF THE DRAWINGS

FIG. 1 is a schematic representation of a first example embodiment of the invention, in which cycle inputs and processing means are emphasized.

FIG. 2 is a schematic representation of the example embodiment of the invention depicted in FIG. 1, in which product and waste outputs are emphasized.

### DETAILED DESCRIPTION OF SEVERAL EXAMPLE EMBODIMENTS

The desalination process disclosed herein is essentially a thermal multiple effect evaporation process, which uses cascading steam pressures and temperatures to produce various effects. One unique feature of the system is the ability to recover waste heat from an associated internal combustion engine. The process differs from conventional evaporation units in many ways, for example, by using a parallel feed rather than series forward flow or series counter flow. The series feed flow in either concurrent flow or counter flow toward the steam flow may also be used depending on the specific application and optimization.

For ease of understanding, an example process flow for a three-effect evaporator with parallel feed is shown and described, though those of ordinary skill in the art will readily appreciate that evaporators comprising series feed and more than three effects will also fall within the spirit and scope of the instant disclosure.

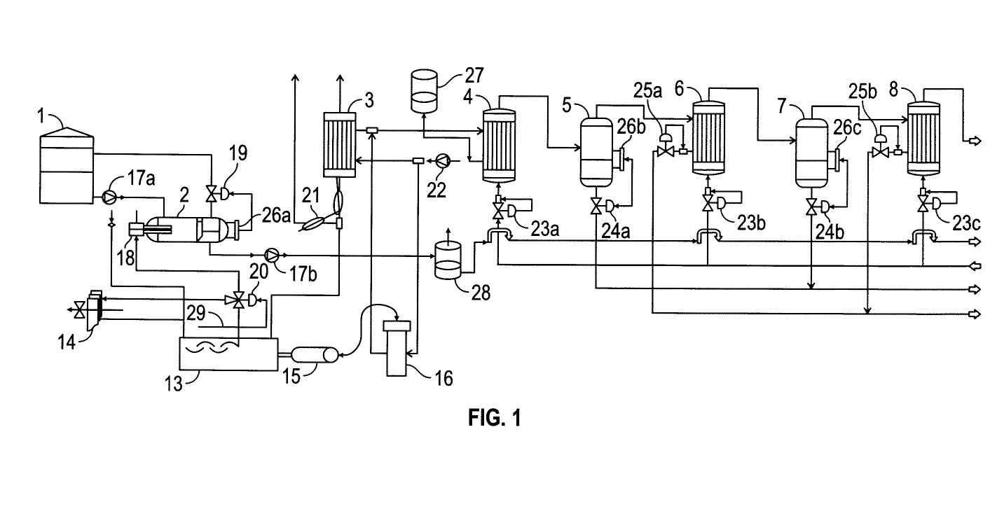

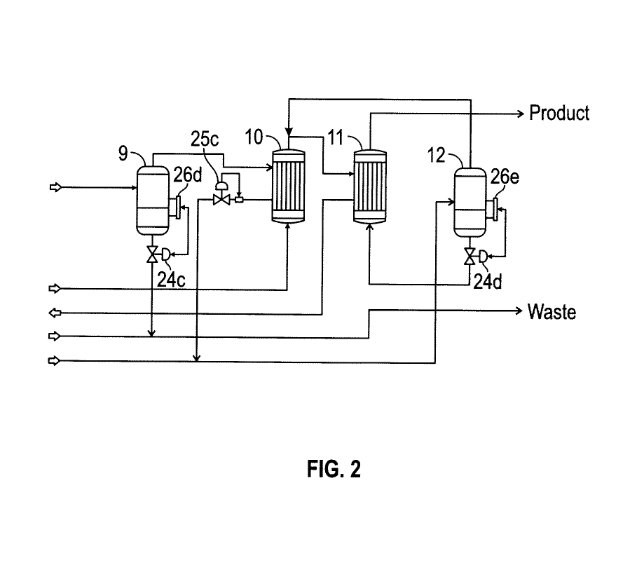

With reference now to attached FIGS. 1 and 2, equipment and instrumentation consistent with presently contemplated commercial embodiments may be found in Table 1 below, though again, ordinarily skilled artisans will appreciate that this listing is for illustrative purposes only, and is not intended to limit the scope of the disclosure or similar or equivalent structures and systems. For example, in one specific though non-limiting embodiment, both an evaporator and a separator can be combined within a single kettle type unit, etc.

TABLE 1
Basic List of Equipment and Instruments

| Tag No. | | Description |
|---|---|---|
| 1 | | Oil - Brine Separation/Storage Tank |
| 2 | | Oil-Brine Two Phase Separator Drum |
| 3 | | Exhaust Heat Recovery Heat Exchanger |
| 4 | | First Effect Evaporator/Heat Exchanger |
| 5 | | First Effect Brine Steam Separator |
| 6 | | Second Effect Evaporator/Heat Exchanger |
| 7 | | Second Effect Brine Steam Separator |
| 8 | | Third Effect Evaporator/Heat Exchanger |
| 9 | | Third Effect Brine Steam Separator |
| 10 | | Condenser |
| 11 | | Product Heat Recovery Heat Exchanger |
| 12 | | Product Flash Tank |
| 13 | | Internal Combustion Engine |
| 14 | | Air Cooler |
| 15 | | Electric Generator |
| 16 | | Electric Heater coil |
| 17 | a/b | Brine Transfer Pump/Brine Feed Pump |
| 18 | | Oil-Brine Separator Heater Coil |
| 19 | | Oil Return Control Valve |
| 20 | | Engine Coolant Three-Way Valve |
| 21 | | Engine Exhaust Damper Control |
| 22 | | Heat Transfer Fluid Circulating Pump |
| 23 | a/b/c | Pressure Regulating Valve |
| 24 | a/b/c/d | Liquid Level Control Valve |
| 25 | a/b/c | Back Pressure Control Valve |
| 26 | a/b/c/d/e | Liquid Level Controller |
| 27 | | Expansion Tank |
| 28 | | Air Separator/Vent |
| 29 | | Temperature Controller |

A. Brine Preparation

With reference now to FIGS. 1 and 2, in one specific though non-limiting embodiment production water is transferred by Brine Transfer Pump (17a) from an Oil-Brine Separation/Storage Tank (1) to an Oil-Brine Two-Phase Separator Drum (2). In the representative embodiment depicted herein, Oil-Brine Two-Phase Separator Drum (2) separates residual oil from the brine using a plurality of coalescer elements. The oily brine is then heated by an Oil-Brine Separator Heater Coil (18).

Heating the oily brine enhances the separation of oil from brine. The coalescer elements in Oil-Brine Two-Phase Separator Drum (2) coalesces minute particles of oil into larger particle and float, thereby separating it from the brine. The quantity of oil after the coalescing process is determined in large part by Liquid Level Controller (26a), which opens an Oil Return Control Valve (19) if a predetermined quantity of oil level is detected and deemed sufficient to be returned to Oil-Brine Separation/Storage Tank (1).

In a further embodiment, heat energy used to heat the brine in Oil-Brine Two-Phase Separator Drum (2) is derived from heat recovered from an Internal Combustion Engine (13) jacket cooling system. An engine pump circulates coolant to Oil-Brine Separator Heater Coil (18), thereby dissipating heat to the brine disposed in the Oil-Brine Two-Phase Separator Drum (2), which necessarily raises the temperature of the brine.

In one embodiment, an Engine Coolant Three-Way Valve (20) controls the temperature of the coolant entering the Internal Combustion Engine jacket cooling system by means of a Temperature Controller (29). The Engine Coolant Three Way Valve (20) port going to Oil-Brine Separator Heater Coil (18) is normally open, and the port towards Air Cooler (14) is normally closed.

When the temperature of the coolant coming back from Oil-Brine Separator Heater Coil (18) at the inlet of the Internal Combustion Engine is higher than the set point of the Temperature Controller (29), coolant is diverted to an Air Cooler (14) in order to vent heat to the atmosphere. In certain embodiments, the Air Cooler (14) fan only operates when heat from the Internal Combustion Engine jacket cooling system is more than the heating requirement of the oily brine in the Oil-Brine Two-Phase Separator Drum (2); otherwise, the fan is turned off.

B. Pre-Heating by Process Heat Recovery

In other embodiments, the feed brine is pre-heated with heat recovered from the process. The separated brine from the Oil-Brine Two-Phase Separator Drum (2) is fed to the system by Brine Feed Pump (17b). The brine passes to the Air Separator/Vent (28), where air is vented to the atmosphere. The brine is degassed from this air separator. The brine is pre-heated to a higher temperature after passing through the Condenser (10), and then further heated to a higher temperature with heat recovered from Product Heat Recovery Heat Exchanger (11).

C. Production of Heat Energy for Evaporation

In other embodiments, the heat energy required for evaporation of the single steam from the First Effect Evaporator/Heat Exchanger (4) is supplied by Exhaust Heat Recovery Heat Exchanger (3) and Electric Heater (16) via heat transfer fluid circulated by Heat Transfer Fluid Circulating Pump (22). The heat energy from heat Exhaust Heat Recovery Heat Exchanger (3) is the heat recovered from the exhaust gas of the Internal Combustion Engine (13). In other embodiments, the electric energy supplied to Heater Coil (16) is the electric energy produced by the Electric Generator (15). In this embodiment, the heat energy from both sources is needed to maximize the use of Engine-Generator set (13) and (15).

In further embodiments, the heat energy from Exhaust Heat Recovery Heat Exchanger (3) is controlled by Engine Exhaust Damper Control (21). This Engine Exhaust Damper Control (21) modulates to meet the energy requirement of Exhaust Heat Recovery Heat Exchanger (3). The Electric Heater (16) is controlled by its own temperature controller. Both energy sources (3) and (16) are monitored and controlled by the thermal controller of First Effect Evaporator/Heat Exchanger (4).

In still further embodiments, the heat transfer loop is a closed loop using high temperature oil heat transfer fluid. The heating loop is provided with Expansion Tank (27) to protect the system from high pressure due to expansion of the heat transfer fluid inside the piping and equipment in the loop when the system is subjected to different and varying temperatures.

D. Producing a First Steam in the First Effect Evaporator/Heat Exchanger

In other embodiments, a First Steam is produced in the First Effect Evaporator/Heat Exchanger (4). The heat energy as described above in Paragraph C (regarding Heat Energy for Evaporation), and is used to evaporate some of the water from the feed brine which was pre-heated as described in paragraph B (regarding Pre-Heating by Process Heat Recovery). In the depicted embodiments, the brine leaves First Effect Evaporator/Heat Exchanger (4) in two-phases (steam and brine). The mixture is then piped to the First Effect Brine Steam Separator (5) where the steam is separated from the brine. Subsequently, the steam is extracted from the top of the vessel of First Effect Brine Steam Separator (5) and brine exits at the bottom.

The pressure of the brine supplied to this stage is controlled by Pressure Regulating Valve (23a). The Pressure Regulating Valve (23a) pressure setting is set to the design pressure. This set pressure is higher than the pressure in the next stage. This set pressure also determines the steam saturation temperature of this stage. During operation, the steam pressure in this stage is controlled by the Back Pressure Control Valve (25a) located in the drip leg of Second Effect Evaporator/Heat Exchanger (6).

The liquid level of waste brine in First Effect Brine Steam Separator (5) is controlled by Liquid Level Controller (26b) that opens and closes the Liquid Level Control Valve (24a). The waste is collected in the waste header that mixes the waste from other waste legs.

E. Producing a Second Steam and First Distillate in Second Effect Heat Exchanger

In further embodiments still, the First Steam produced by the First Effect Evaporator/Heat Exchanger (4) via First Effect Brine Steam Separator (5) is piped to Second Effect Evaporator/Heat Exchanger (6). The steam in the hot side of the Second Effect Evaporator/Heat Exchanger (6) condenses, thereby transferring the heat energy to the brine on the cold side of the heat exchanger. This process evaporates some of the water from the feed brine which was pre-heated as described in paragraph B (regarding Pre-Heating by Process Heat Recovery).

The brine then leaves Second Effect Evaporator/Heat Exchanger (6) in two-phases (steam and brine). This mixture is piped to the Second Effect Brine Steam Separator (7), where the steam is separated from the brine. Again, the steam is extracted from the top of the vessel of Second Effect Brine Steam Separator (7), and brine exits at the bottom.

In alternative embodiments, the pressure of the brine supplied to this stage is controlled by Pressure Regulating Valve (23b). In the depicted embodiment, the valve pressure setting is set to the stage design pressure. This set pressure is lower than previous stage but higher than the pressure in the next stage. This set pressure also determines the steam saturation temperature of this stage. During operations the steam pressure in this stage is controlled by the Back Pressure Control Valve (25b) located in the drip leg of Third Effect Evaporator/Heat Exchanger (8).

The liquid level of waste brine in Second Effect Brine Steam Separator (7) is controlled by Liquid Level Controller (26c), which opens and closes the Liquid Level Control Valve (24b). The waste is collected in the waste header that mixes the waste from other waste legs.

The First Distillate produced in this stage is controlled by the Back Pressure Control Valve (25a) located in the drip leg of Second Effect Evaporator/Heat Exchanger (6), and the drip is collected in a header that mixes the distillate from other drip legs.

F. Producing a Third Steam and Second Distillate in a Third Effect Heat Exchanger

In further embodiments, the steam produced by the Second Effect Evaporator/Heat Exchanger (6) via Second Effect Brine Steam Separator (7) is piped to Third Effect Evaporator/Heat Exchanger (8). The steam in the hot side of the Third Effect Evaporator/Heat Exchanger (8) condenses, thereby transferring the heat energy to the brine on the cold side of the heat exchanger. The process evaporates some of the water from the feed brine which was pre-heated as described in paragraph B (regarding Pre-Heating by Process Heat Recovery). The brine leaves Third Effect Evaporator/Heat Exchanger (8) in two-phase (steam and brine). The mixture is piped to the Third Effect Brine Steam Separator (9) where the steam is separated from the brine. The steam is extracted from the top of the Third Effect Brine Steam Separator (9) and brine exits at the bottom.

The pressure of the brine supplied to this stage is controlled by Pressure Regulating Valve (23c). This valve pressure setting is set to the stage design pressure. This set pressure is lower than previous stage. This set pressure also determines the steam saturation temperature of this stage. During operations the steam pressure in this stage is controlled by the Back Pressure Control Valve (25c) located in the drip leg of Condenser (10).

In this embodiment, the waste liquid level of brine in Third Effect Brine Steam Separator (9) is controlled by Liquid Level Controller (26d), which opens and closes the Liquid Level Control Valve (24c). The waste is collected in the waste header that mixes the waste from other waste legs, and is then piped to a waste storage tank

The Second Distillate produced in this stage is controlled by the Back Pressure Control Valve (25b) located in the drip leg of Third Effect Evaporator/Heat Exchanger (8), and again the drip is collected in header that mixes the distillate from other drip legs.

G. Producing a Third Distillate and Process Heat Recovery in a Condenser

In other embodiments, the Steam produced by the Third Effect Evaporator/Heat Exchanger (8) via Third Effect Brine Steam Separator (9) is piped to Condenser (10). The steam in the hot side of the Condenser (10) condenses transferring the heat energy to the brine on the cold side of the heat exchanger and, in the process, heating feed brine coming from the Air Separator/Vent (28). The brine inlet temperature is lower that the steam saturation temperature. The brine leaves Condenser (10) at higher temperature.

The Third Distillate produced in this stage is controlled by the Back Pressure Control Valve (25c) located in the drip leg of Condenser (10), and the drip is collected in header that mixes with the distillate from other drip legs.

H. Process Heat Recovery in Product Heat Recovery Heat Exchanger

In still further embodiments, the drips collected from the drip legs and piped to Product Flash Tank (12). The Distillate being at high pressure and temperature will flash and produce steam as it enters Product Flash Tank (12) at lower pressure. The flashed steam is extracted and piped to Condenser (10) and condenses with the steam from Third Effect Brine Steam Separator (9).

The Distillate from Product Flash Tank (12) is piped to Product Heat Recovery Heat Exchanger (11). This serves as a hot fluid, and the brine from Condenser (10) serves as the cold fluid. The feed brine leaves the Product Heat Recovery Heat Exchanger (11) at a higher temperature passing through the final stage of pre-heating, thereby optimizing the heat recovery process of the system. The cooler Distillate leaving the Product Heat Recovery Heat Exchanger (11) will be piped to a product storage tank.

The foregoing description is intended primarily for illustrative purposes, and is not intended to include all possible aspects of the present invention. Moreover, while the invention has been shown and described with respect to a presently preferred embodiment, those of ordinary skill in the art will appreciate that the description, and various other modifications, omissions and additions, so long as in the general form and detail, may be made without departing from either the spirit or scope thereof.

1. A system for brine water desalinization, said system comprising
means for brine preparation;
means for pre-heating brine using process heat recovery;
means for producing heat energy for evaporation;
means for producing a first steam in a first effect heat exchanger;
means for producing a second steam and a first distillate in a second effect heat exchanger;
means for producing a third steam and a second distillate in a third effect heat exchanger;
means for producing a third distillate in a condenser; and
means for recovering process heat in a product heat recovery heat exchanger.

2. The system for brine water desalinization of claim 1, wherein said means for brine preparation further comprises:
an oil-brine water storage and separation tank;
an oil-brine water transfer pump;
an oil-brine two-phase separator drum; and
an oil-brine separator heating coil.

3. The system for brine water desalinization of claim 1, wherein said means for pre-heating brine using process heat recovery further comprises:
a brine feed pump;
a first air separator;
a condenser; and
a product heat recovery heat exchanger.

4. The system for brine water desalinization of claim 1, wherein said means for producing heat energy for evaporation of heat energy further comprises:
an exhaust heat recovery heat exchanger;
an electric heater;
a heat transfer fluid circulation pump; and
a first effect heat exchanger.

5. The system for brine water desalinization of claim 1, wherein said means for producing a first steam further comprises:
a first effect heat exchanger;
a first effect brine steam separator, wherein said first effect brine steam separator further comprises a first liquid level controller and a first liquid level control valve; and
a first pressure regulating valve.

6. The system for brine water desalinization of claim 1, wherein said means for producing a second steam and a first distillate further comprises:
a second effect heat exchanger disposed in communication with a first back pressure control valve;
a second effect brine steam separator, wherein said second effect steam separator further comprises a second liquid level controller and a second liquid level control valve; and
a second pressure regulating valve.

7. The system for brine water desalinization of claim 1, wherein said means for producing a third steam and a second distillate further comprises:
a third effect heat exchanger disposed in fluid communication with a second back pressure control valve;
a third effect brine steam separator, wherein said third effect steam separator further comprises a third liquid level controller and a third liquid level control valve; and
a third pressure regulating valve.

8. The system for brine water desalinization of claim 1, wherein said means for producing a third distillate further comprises:
a condenser disposed in fluid communication with said third steam and a second air separator; and
a third back pressure control valve.

9. The system for brine water desalinization of claim 1, wherein said means for recovering process heat further comprises:
a product flash tank disposed in fluid communication with said condenser and said third effect brine steam separator; and
a product recovery heat exchanger.

10. A system for brine water desalinization, said system comprising
means for brine preparation, wherein said means for brine preparation further comprises an oil-brine water storage and separation tank; an oil-brine two-phase separator drum; and an oil-brine separator heater coil;
means for pre-heating brine using process heat recovery, wherein said means for pre-heating brine using process heat recovery further comprises a brine feed pump; a first air separator; a first condenser; and a product heat recovery heat exchanger;
means for evaporation wherein said means for evaporation further comprises an exhaust heat recovery heat exchanger; an electric heater; high temperature heat transfer fluid; a heat transfer fluid circulation pump; and a first effect heat exchanger;
means for producing a first steam in a first effect heat exchanger, wherein said means for producing a first steam further comprises a first effect heat exchanger; a first effect brine steam separator, wherein said brine steam separator further comprises a first liquid level controller and a first liquid level control valve; and a first pressure regulating valve;
means for producing a second steam and a first distillate in a second effect heat exchanger, wherein said means for producing said second steam and said first distillate further comprises a second effect heat exchanger, wherein said second effect heat exchanger further comprises a first back pressure control valve; second effect brine steam separator, wherein said second effect steam separator further comprises a second liquid level controller and a second liquid level control valve; and a second pressure regulating valve;
means for producing a third steam and a second distillate in a third effect heat exchanger, wherein said means for producing said third steam and said second distillate further comprises a effect heat exchanger, wherein said third effect heat exchanger further comprises a second back pressure control valve; a third effect brine steam separator, wherein said third effect steam separator further comprises a third liquid level controller and a third liquid level control valve; and a third pressure regulating valve;
means for producing a third distillate in a condenser, wherein said means for producing a third distillate further comprises a condenser disposed in fluid communication with said third steam and a second air separator; and a third back pressure control valve; and
means for recovering process heat in a product heat recovery heat exchanger, wherein said means for recovering process heat further comprises a product flash tank disposed in fluid communication with said condenser and said third effect brine steam separator; and a product recovery heat exchanger.

11. A method for brine water desalinization, said method comprising
disposing a means for brine preparation in communication with a means for pre-heating brine using process heat recovery;
disposing said means for pre-heating brine using process heat recovery in communication with a means for evaporation;
disposing said means for evaporation in communication with a means for producing a first steam in a first effect heat exchanger;
disposing said means for producing a first steam in a first effect heat exchanger in communication with a means for producing a second steam and a first distillate in a second effect heat exchanger;
disposing said means for producing a second steam and a first distillate in a second effect heat exchanger in communication with a means for producing a third steam and a second distillate in a third effect heat exchanger;
disposing said means for producing a third steam and a second distillate in a third effect heat exchanger in communication with a means for producing a third distillate in a condenser; and
disposing said means for producing a third distillate in a condenser in communication with a means for recovering process heat in a product heat recovery heat exchanger.

12. The method for brine water desalinization of claim 11, wherein said disposing a means for brine preparation further comprises:
disposing an oil-brine water storage and separation tank in communication with an oil-brine two-phase separator drum and an oil-brine separator heating coil.

13. The method for brine water desalinization of claim 11, wherein said disposing a means for pre-heating brine using process heat recovery further comprises:
disposing a brine feed pump in communication with a first air separator, a condenser and a product heat recovery heat exchanger.

14. The method for brine water desalinization of claim 11, wherein said disposing a means for evaporation further comprises:
disposing an exhaust heat recovery heat exchanger in communication with an electric heater, a high temperature heat transfer fluid; a heat transfer fluid circulation pump, and a first effect heat exchanger.

15. The method for brine water desalinization of claim 11, wherein said disposing a means for producing a first steam further comprises:
disposing a first effect heat exchanger in communication with a first effect brine steam separator, wherein said first effect brine steam separator further comprises a first liquid level controller and a first liquid level control valve; and a first pressure regulating valve.

16. The method for brine water desalinization of claim 11, wherein said disposing a means for producing a second steam and a first distillate further comprises:
disposing a second effect heat exchanger disposed in communication with a first back pressure control valve; a second effect brine steam separator, wherein said second effect steam separator further comprises a second liquid level controller and a second liquid level control valve; and a second pressure regulating valve.

17. The method for brine water desalinization of claim 11, wherein said disposing a means for producing a third steam and a second distillate further comprises:
disposing a third effect heat exchanger disposed in fluid communication with a second back pressure control valve; a third effect brine steam separator, wherein said third effect steam separator further comprises a third liquid level controller and a third liquid level control valve; and a third pressure regulating valve.

18. The method for brine water desalinization of claim 11, wherein said disposing means for producing a third distillate further comprises:
disposing a condenser in fluid communication with said third steam, a second air separator, and a third back pressure control valve.

19. The method for brine water desalinization of claim 11, wherein said disposing a means for recovering process heat further comprises:
disposing a product flash tank in fluid communication with said condenser, said third effect brine steam separator; and a product recovery heat exchanger.
